(19) United States
(12) Patent Application Publication
(10) Pub. No.: US 2013/0250588 A1
(43) Pub. Date: Sep. 26, 2013

(54) Two-Way Theft Resistant Light Flange

(71) Applicants: Jose A. Villamizar, Medley, FL (US); Diego J. Villamizar, Medley, FL (US); Jairo A. Villamizar, Medley, FL (US)

(72) Inventors: Jose A. Villamizar, Medley, FL (US); Diego J. Villamizar, Medley, FL (US); Jairo A. Villamizar, Medley, FL (US)

(21) Appl. No.: 13/424,384

(22) Filed: Mar. 20, 2012

(51) Int. Cl. F21V 21/00

(52) U.S. Cl. 362/382

(57) ABSTRACT

A two-way theft resistant light flange that restricts both front and rear disengagement of a vehicle light fixture from a light flange for preventing the theft and vandalism of vehicle lights, while also retaining structural integrity of the two-way theft resistant light flange. The two-way theft resistant light flange accomplishes this task by utilizing numerous anti-theft components. A lip that circumscribes the inner perimeter and a plurality of knobs or ridges restrict movement of the light fixture in one direction; while a plurality of retaining clips restrict movement of the light fixture in the opposite direction. Principles of dry friction force and enhanced secure attachment components to the vehicle also provide anti-theft capabilities. The two-way theft resistant light flange also retains its structural integrity by fabricating and orienting the security components in a strategic manner.

### BACKGROUND

The present invention is directed to a two-way theft resistant light flange that restricts both front and rear disengagement of a vehicle light from a light flange for preventing the theft and vandalism of vehicle lights, while also retaining structural integrity of the light flange.

The inventors of the present invention are truck part manufacturers who enjoy working on trucks. They also enjoy developing the most state of the art accessories for trucks. One of the most popular accessories for trucks is an eclectic variety of unique and expensive light fixtures that create an aesthetic effect inside the light rims, roll cages, and rear structures of trucks. The inventors affix these novel lights in specially designed light flanges of trucks. In practice, they install the light fixtures to either a plug or an electrical connector. The light fixtures are normally installed into the flange by placing the light fixture from the rear of the flange toward the front of the flange. Sometimes, installers install the light fixtures by popping the light fixture into the light flange. The inventors recognized that the light fixtures could also pop out of the light flange just as easily when they replaced the light fixture—even with the anti-theft variety of light flanges. After some unfortunate experiences having their light fixtures forcibly removed by vandals and thieves, the inventors realized that the fancy lighting fixtures they enjoyed embellishing on trucks with, created a two edged sword, in that they attracted attention from both truck admirers and thieves.

The truck industry utilizes numerous anti-theft light flanges to protect expensive light fixtures from theft. However, the thieves are adept at stealing the light fixtures by simply reaching behind the light flange and ejecting the light fixture forward. When the truck industry utilized a light flange with a circumscribing protruding groove for restricting movement of the light fixture forward in the light flange, the thieves simply utilized prying tools such as screw drivers on the screw holes of the support base and removed the entire light flange from the truck; with the resultant being that the light fixture would simply pop out with the light flange. Another problem the truck industry encountered with the light fixture thieves was that they also ejected the light fixture towards the rear of the truck. Then the thieves simply reached behind the light flange and took the light fixture. It is recognized that the two-way theft resistant light flange's of the present invention can be used on a variety of other vehicles other than trucks.

After many years of trial and error, the truck industry finally obtained a light flange that restricted forcible movement of the light fixture in both the forward and rear directions. The light flange utilized retaining clips and notches that restricted movement from both the front and the rear of the truck. However, since the retaining clips were simply a part of the light flange inner circumference, the light flange included many gaps, indentations, depressions, and protruding clips. These voids in the light flange inner circumference reduced the integrity of the light flange. Often, the retaining clip would simply break off if a large enough force was applied, such as a rough road, or a forceful thief.

The truck industry studied a host of scientific articles regarding dry friction force to better understand how two static structures, such as the light fixture and the light flange, could best resist relative lateral motion from each other. They discovered scholarly articles found on websites like:

http://ruina.tam.cornell.edu/research/topics/friction_and_fracture/GoyalPhDThesis.pdf, and http://bdml.stanford.edu/twiki/pub/Main/NoeEsparza/Goval1989_LimitSurface_powerMethod.pdf. They pieced this information together and, over time, recognized that it was possible to include in the light flange inner circumference, a lip that circumscribed the inner circumference. The lip was efficacious in preventing movement of the light fixture towards the forward position relative to the vehicle. After trial and error, the truck industry further realized that including a plurality of protuberance members, such as knobs, ridges, or pleats adjacent to the lip would enhance the restriction of the light fixture in the forward direction. Thereafter, the truck industry utilized the new light flange, and thieves could not expel the light fixture from the rear towards the front of the truck. However, the thieves could still use a strong force to expel the light fixture towards the rear of the truck.

Through past consumption and knowledge in the light flange field, the truck industry was aware that retaining clips and twist locks were efficacious in restricting movement. However, they also knew that these retaining clips and twist locks reduced the overall integrity of the light flange because they were cut from the extreme ends of the light flange inner circumference. To avoid weakening the extreme ends of the light flange inner circumference, the truck industry cut out the retaining clips from the center of the light flange inner circumference, rather than from the extreme ends. They also oriented the retaining clip so that it would prevent the light fixture from moving towards the rear of his truck, facing a top end of the light flange. Thereby, the truck industry had developed a two-way restriction of movement for the light fixture after it was positioned into the light flange. The truck industry further realized that if the retaining clips were dimensioned small enough, and away from the extreme ends, the integrity of the overall light flange was maintained.

Despite these new processes, the truck industry still recognized that they had to create the right support base for the light flange to securely affix to the truck. This last step is where the truck industry had difficulties in the past, and where many of the expenses originated. After much trial and error, the truck industry finally settled on drilling apertures, such as screws around the perimeter of the light flange support base. They then created depression around the screw holes to improve the structural integrity of the screw hole as it pressed against the vehicle.

Theft resistant light flanges have been utilized in the past; yet none with the present two-way movement restrictions and structural integrity of the present invention. See U.S. Pat. Nos. 7,278,763; 6,062,709; and 6,302,569.

For the foregoing reasons, there is an effective two-way theft resistant light flange that restricts movement of the light fixture in both the forward and rear directions, retains structural integrity, and securely affixes to the vehicle.

### SUMMARY

The present invention is directed to a two-way theft resistant light flange that restricts both front and rear movement of a vehicle light fixture from a light flange. This restriction of movement prevents the theft and vandalism of vehicle light fixtures, while also retaining structural integrity of the light flange. The light flange comprises of numerous novel features for preventing a truck, vehicle or trailer light from being forcibly dislodged from its light flange.

One such novel theft prevention feature is a channel that forms a lip around the interior perimeter of the light flange sleeve member. The lip restricts movement of the light fixture towards a top end of the two-way theft resistant light flange by serving as a physical barrier to the light fixture. Thereby it is not possible to disengage the light fixture by applying force from a bottom end towards the top end of the two-way theft resistant light flange. Numerous protuberance members, such as knobs or ridges also align the interior perimeter of the light flange sleeve member to enhance the bottom end movement restrictiveness of the light flange. The lip and the knobs work together to provide a sufficiently strong physical resistance to the relative lateral motion between the light fixture and the light flange, thereby also restricting movement towards the top end of the two-way theft resistant light flange.

Finally, built in retaining clips are configured to engage a light fixture ledge as the light fixture is positioned inside the light flange. The retaining clips are efficacious in restricting movement of the light towards bottom end of the two-way theft resistant light flange by providing supports that orient towards the top end. Thereby, applying a force from the top end onto the light fixture will not disengage the light fixture from the bottom end, or rear of the vehicle. The retaining clips are located adjacent to the lip, and substantially centrally located on the light flange sleeve member to retain the structural integrity of the light flange, and prevent breakage. The synergy created by the two-way vehicle light theft prevention flange between these theft prevention components eliminates vehicle light theft from the flange.

The light flange provides an additional security feathre pertinent to its attachment to the vehicle. A plurality of support base apertures are positioned around the support base for receiving a fastener, and securing to the vehicle. Those skilled in the art can appreciate that the support base apertures are often screw holes, but can include any other type of aperture now known or later developed. Each support base aperture also includes an aperture depression configured to providing a better fit for the fastener. The aperture depression circumscribes the support base apertures to provide a more snug coupling between the fastener and the support base apertures. This increases the difficulty of forcefully removing the light fastener from the vehicle. In one embodiment, at least one washer positions between the fastener and the aperture depression.

An object of the present invention is to restrict the movement of the light fixture inside the light flange towards both the forward direction and the rear direction relative to the vehicle. This is accomplished by utilizing numerous anti-theft features such as the lip and the protuberance members (knobs) to restrict movement towards the front of the vehicle, and the retaining clips to restrict movement towards the rear of the vehicle. Each support base aperture also includes an aperture depression to provide a more secure attachment to the vehicle.

Another object of the present invention is to retains its structural integrity by fabricating and orienting the security components in a strategic manner.

Another object of this invention is to utilize a dry friction force between the light fixture and the light flange so that their contact surfaces resist relative lateral motion from each other.

Yet another object of this invention is to reduce the cost of replacing expensive light fixtures by eliminating theft from the light flanges on vehicles.

### DRAWINGS

These and other features, aspects, and advantages of the present invention will become better understood with regard to the following description, appended claims, and drawings where:

FIG. 1 is a perspective view of the present invention showing the inner circumference of a light flange sleeve member;

FIG. 2 is a top planar view of the present invention; and

FIG. 3 is a sectioned side view of the present invention, and a detailed view of the interaction between a retaining clip member and a light fixture ledge.

### DESCRIPTION

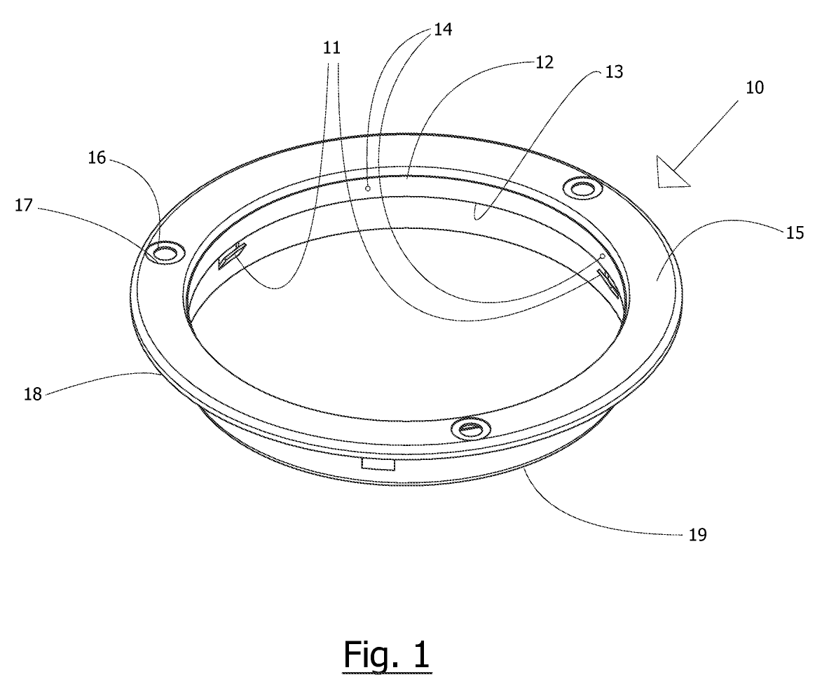

One embodiment of the two-way theft resistant light flange 10 is illustrated in FIGS. 1-3. The two-way theft resistant light flange 10 comprises of the following: A bottom end 19 that includes a light flange sleeve member 12. The inner circumference of the light flange sleeve member 12 creates a dry friction force against a light fixture 20, whereby the contact surfaces of the inner circumference of the light flange sleeve member 12 and the light fixture 20 resist relative lateral motion when engaged. In one embodiment, ridges, serrations, and voids can be incorporated into the light flange sleeve member 12 and the light fixture 20 to increase the dry friction force between the inner circumference of the light flange sleeve member 12 and the light fixture 20. The light flange sleeve member 12 comprises of a lip member 13 for restraining movement of the light fixture 20. The lip member 13 circumscribes the inner circumference of the light flange sleeve member 12 and restricts directional movement of the light fixture 20 towards a top end 18 of the two-way theft resistant light flange 10 by acting as a physical barrier to the light fixture 20. The light flange sleeve member 12 further comprises of a plurality of protuberance members 14. The plurality of protuberance members 14 also circumscribe the inner circumference of the light flange sleeve member 12 to restrict directional movement of the light fixture 20 towards a top end 18 of the two-way theft resistant light flange 10 by acting as a physical barrier to the light fixture 20; thereby enhancing the effect of the lip member 13. Those skilled in the art can appreciate that the plurality of protuberance members 14 do not necessarily require equidistant or parallel orientation to be effective in acting as physical barriers against the light fixture 20. In one embodiment, the plurality of protuberance members 14 are dimensioned to be knobs or ridges, spatially oriented around the inner circumference of the light flange sleeve member 12.

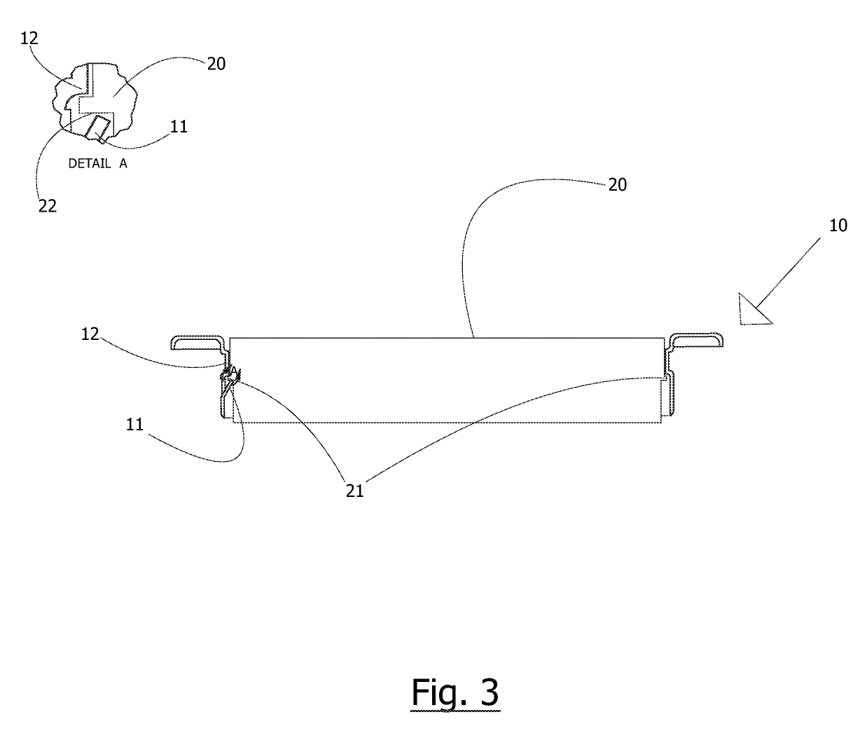

The light flange sleeve member 12 further comprises of a plurality of retaining clip members 11. The plurality of retaining clip members 11 are efficacious in restricting movement of the light fixture 20 towards the bottom end 19 of the two-way theft resistant light flange 10 by providing support that orients towards the top end 18 (See FIG. 1). This is the vital security component that allows the two-way theft resistant light flange 10 to restrict movement in a “two-way” manner—the top end 18 and the bottom end 19 of the two-way theft resistant light flange 10. Consequentially, applying a force from the front of the vehicle onto the light fixture 20 will not disengage the light fixture 20 from the light flange sleeve member 12. The plurality of retaining clip members 11 are located adjacent to the lip member 13, and substantially centrally located on the light flange sleeve member 12 to retain the structural integrity of the whole two-way theft resistant light flange 10, and preventing breakage. Those skilled in the art can appreciate that myriad types of clips are available, such as rotor clips, eclips, snap rings, circlips, and the like. Each retaining clip member 11 engages with a correlating light fixture ledge 22 to contribute towards a secure connection between the light flange sleeve member 12 and the light fixture 20 (See FIG. 3).

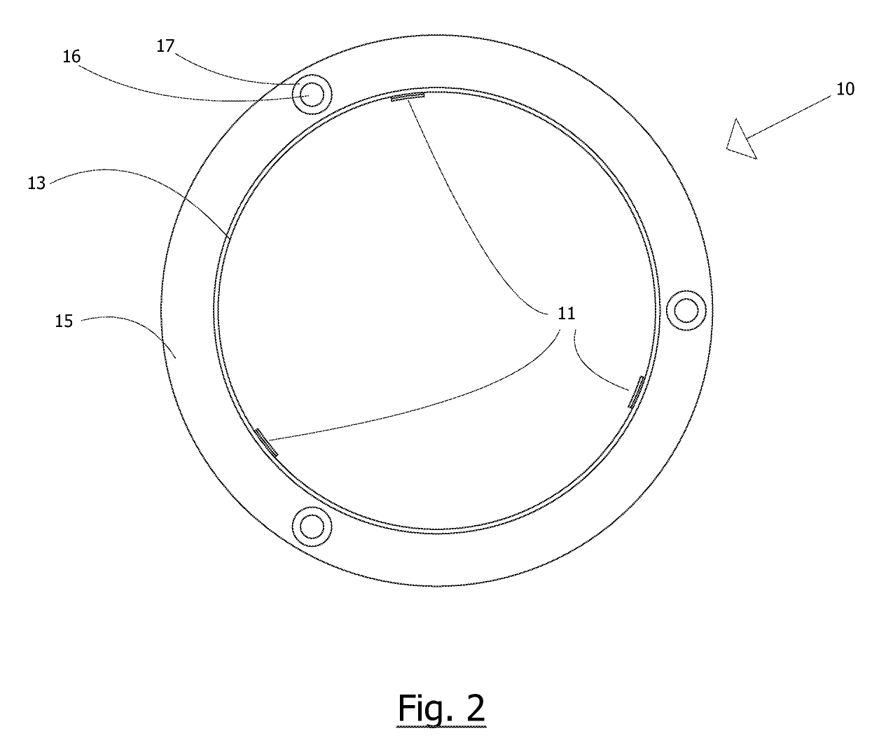

A top end 18 of the two-way theft resistant light flange 10 includes a light flange support base 15 that extends perpendicularly from the light flange sleeve member 12 (See FIG. 2). The light flange support base 15 provides a foundation to securely affix the two-way theft resistant light flange 10 to the vehicle. The light flange support base 15 comprises of a plurality of support base apertures 16. The plurality of support base apertures 16 comprise of a plurality of aperture depressions 17. The plurality of support base apertures 16 are positioned around the support base 15 for receiving a fastener, and securing to the vehicle. Those skilled in the art can appreciate that the plurality of support base apertures 16 are often screw holes, but can include any other type of aperture now known or later developed. Each support base aperture 16 also includes an aperture depression 17 configured to providing a better fit against the fastener. Each aperture depression 17 circumscribes each support base aperture 16 to provide a snug coupling between the fastener and the plurality of support base apertures 16. The coupling effect increases the difficulty of forcefully removing the two-way theft resistant light flange 10 from the vehicle. In one embodiment, at least one washer positions between the fastener and each aperture depression 17.

The two-way theft resistant light flange of the present invention can be made of stainless steel, aluminum, ceramic, or fiberglass. In preferred embodiments the material will not be malleable.

An advantage of the present invention is that it drastically reduces the cost of replacing the light fixtures 20 by eliminating theft from the two-way theft resistant light flange 10.

Another advantage of the present invention is that the structural integrity of the plurality of retaining clip members 11 is maintained because they are located adjacent to the lip member 13, and substantially centrally located on the light flange sleeve member 12, rather than near the extreme ends of the light flange sleeve member 12 where breakage is more likely.

Thus the reader will see that the two-way theft resistant light flange 10 provides both a front and a rear directional restriction of movement against the light fixture 20.

While the inventor's above description contains many specificities, these should not be construed as limitations on the scope, but rather as an exemplification of several preferred embodiments thereof. Many other variations are possible. For example, the two-way theft resistant light flange 10 could be utilized for preventing theft of lights in a building by utilizing the same two-way security components, principles of dry friction force, and secure attachment for the building structure. Accordingly, the scope should be determined not by the embodiments illustrated, but by the appended claims and their legal equivalents.

What is claimed is:

1. A two-way theft resistant light flange for restricting movement of a light fixture, the two-way theft resistant light flange comprising:
a bottom end, the bottom end comprising a light flange sleeve member, the light flange sleeve member comprising a lip member, the light flange sleeve member further comprising a plurality of protuberance members, the light flange sleeve member further comprising a plurality of retaining clip members;
a top end, the top end comprising a light flange support base, the light flange support base comprising a plurality of support base apertures, the plurality of support base apertures comprising a plurality of aperture depressions; and
a light fixture, the light fixture comprising at least one light fixture ledge for engaging the plurality of retaining clip members.

2. The two-way theft resistant light flange of claim 1, wherein the plurality of protuberance members are knobs.

3. The two-way theft resistant light flange of claim 2, wherein the plurality of retaining clip members are adjacent to the lip member.

4. The two-way theft resistant light flange of claim 3, wherein the light flange sleeve member is annular shaped.

5. The two-way theft resistant light flange of claim 3, wherein the light flange sleeve member is rectangular shaped.

6. The two-way theft resistant light flange of claim 3, further including ridges, serrations, and voids on the light flange sleeve member to increase the dry friction force with the light fixture.

7. The two-way theft resistant light flange of claim 3, wherein the two-way theft resistant light flange is comprised of stainless steel.

8. The two-way theft resistant light flange of claim 3, wherein the two-way theft resistant light flange is comprised of aluminum.
